(19) United States
(12) Patent Application Publication
(10) Pub. No.: US 2015/0239043 A1
(43) Pub. Date: Aug. 27, 2015

(54) Cast Features for Location and Inspection

(71) Applicant: Siemens Energy, Inc., Orlando, FL (US)

(72) Inventors: Jonathan E. Shipper, JR., Orlando, FL (US); Samuel R. Miller, JR., Port St. Lucie, FL (US); Jae Y. Um, Winter Garden, FL (US); Michael E. Crawford, Oviedo, FL (US); Gary B. Merrill, Orlando, FL (US); Ahmed Kamel, Orlando, FL (US)

(73) Assignee: Siemens Energy, Inc., Orlando, FL (US)

(21) Appl. No.: 14/185,986

(22) Filed: Feb. 21, 2014

(51) Int. Cl. B22D 46/00; B22D 25/02

(52) U.S. Cl. CPC B22D 46/00; B22D 25/02; F05D 2230/21

(57) ABSTRACT

A method for casting an object (12) having an integrated surface feature (10) for location, inspection, and analysis using a feature-based vision system is provided herein that includes determining a shape geometry for a surface feature (10), wherein the shape geometry is adapted for tracking with a feature-based vision system, determining a proper size, placement, and orientation for the surface feature (10) based on a type of inspection, and casting the surface feature (10) into an object (12) at the determined placement and orientation using an investment casting process to produce an integrated surface feature. An object manufactured in accordance with this casting method wherein the object comprises an integrated surface feature (10) for location, inspection, and analysis using a feature-based vision system is also provided

### FIELD OF THE INVENTION

This invention relates to object inspection techniques, and more particularly to cast features applied to parts or objects for location, inspection, and analysis and to inspection methods using said cast features

### BACKGROUND OF THE INVENTION

The detection of image features is an important task in a variety of applications. For example, feature detection is often an initial step in image matching, object recognition, and tracking. Features are specific identified points in the image of an object that a tracking algorithm can lock onto and follow through multiple frames. These features can be used as a calibration tool in the analysis of motion. As a feature is tracked using image analysis and target tracking tools, it becomes a series coordinates that represent the position of the feature across a series of frames. The tracked features are used to develop 2D (x-y) position versus time If multiple cameras are used, 3D (x,y,z) position versus time can be derived. From this information, velocity, acceleration, or other data can also be computed and can indicate changes in the object itself due to twisting, movement, or other deformation. This information may then be combined with data processing and analysis software such as a motion analysis system and used as part of an inspection program to evaluate dimension changes and tolerances.

However, in order to effectively use feature detection, the object must include detectable surface features. To that end, temporary external markers such as self-adhesive reference markers or dots (stickers) are often placed on an object to provide a feature for the tracking algorithm to track when the object is imaged. These types of markers are used, for example, in automotive crash test analysis where quadrant test pattern markers are placed on the crash-test dummy and car for tracking and deformation analysis. Often an arbitrary number of markers are applied by the user as points of measurement onto the surface that is to be measured. As such, the placement of such self-adhesive reference markers may be subject to operator error and will likely vary from object to object.

Virtual markers (see FIG. 2B for example) can also be assigned to existing landmarks on the object for the algorithm to track. Typical landmarks include edges (points where there is a boundary or an edge between two image regions), corners (point-like features in an image), ridges (generally for elongated objects), and blobs (regions in an image that differ in properties, such as brightness or color, compared to areas surrounding those regions) These landmarks may be identified by an operator viewing the images (i.e., the user “cursor traces” edges and features) or by a computer programmed to recognize such, including computer vision algorithms for edge detection, corner detection, blob detection, and the like. However, such landmarks might not correspond with the precise location on the object itself that needs to be tracked to identify a specific movement or deformation for a particular inspection or analysis

Virtual and temporary markers used with feature-based vision systems often fail to provide accurate results because features cannot be easily and consistently identified and tracked from frame to frame and from object to object.

### BRIEF DESCRIPTION OF THE DRAWINGS

The invention is explained in the following description in view of the drawings that show.

FIGS. 1A-1D show close-up views of sample cast features on a surface of an object according to aspects herein.

FIG. 2A illustrates a general turbine blade as the object with placement points indicated thereon for location of the cast features, such as those in FIGS. 1A-1D.

FIG. 2B illustrates a view of virtual points of interest located on a blade.

FIG. 3 is an example view of a leading edge having a plurality of cast features according to aspects herein.

FIG. 4 is a flow chart depicting a method of an embodiment herein

### DETAILED DESCRIPTION OF THE INVENTION

The present invention provides for object inspection techniques based on feature-based vision systems. In particular, detailed features are cast into parts or objects and used for location, inspection, and analysis as part of a feature-based vision inspection method

In an embodiment herein, a method for casting an object having an integrated surface feature for location, inspection, and analysis using a feature-based vision system is provided Generally, as shown in FIG. 4, the method includes determining a shape geometry for a surface feature (or a plurality of surface features) 100, wherein the shape geometry is adapted for tracking with a feature-based vision system, determining a proper size, placement, and orientation for the surface feature based on a type of inspection 110; and casting the surface feature into an object at the determined placement and orientation using an investment casting process to produce an integrated surface feature 112.

The investment casting process can use a flexible mold wherein the surface feature is translated into the master mold using a precision mold insert. In a particular embodiment, the investment casting process uses a flexible mold to cast the feature by forming two master mold halves, one corresponding to each of two opposed sides of a desired ceramic core shape; translating the surface feature into the master mold using a precision mold insert, casting a flexible mold material into each master mold to form two cooperating flexible mold halves, which when joined together define an interior volume corresponding to the desired ceramic core shape, and casting mold material into the flexible mold to cast the object having the surface feature located thereon

Generally, the shape geometry, size, orientation, and placement of the surface feature is adapted to assist in measuring creep, twist, or bowing using a feature-based vision system. In a particular implementation, the object may be a blade or vane such as those used in gas turbine power generation. In a further embodiment herein, the method also includes inspecting the object using a feature-based vision system, wherein the feature-based vision system is adapted to track the surface feature using detection algorithms that locate and detect the surface feature.

An object manufactured in accordance with the casting method herein is also contemplated, wherein the object includes an integrated surface feature for location, inspection, and analysis using a feature-based vision system. In a particular implementation, the object may be a blade or vane

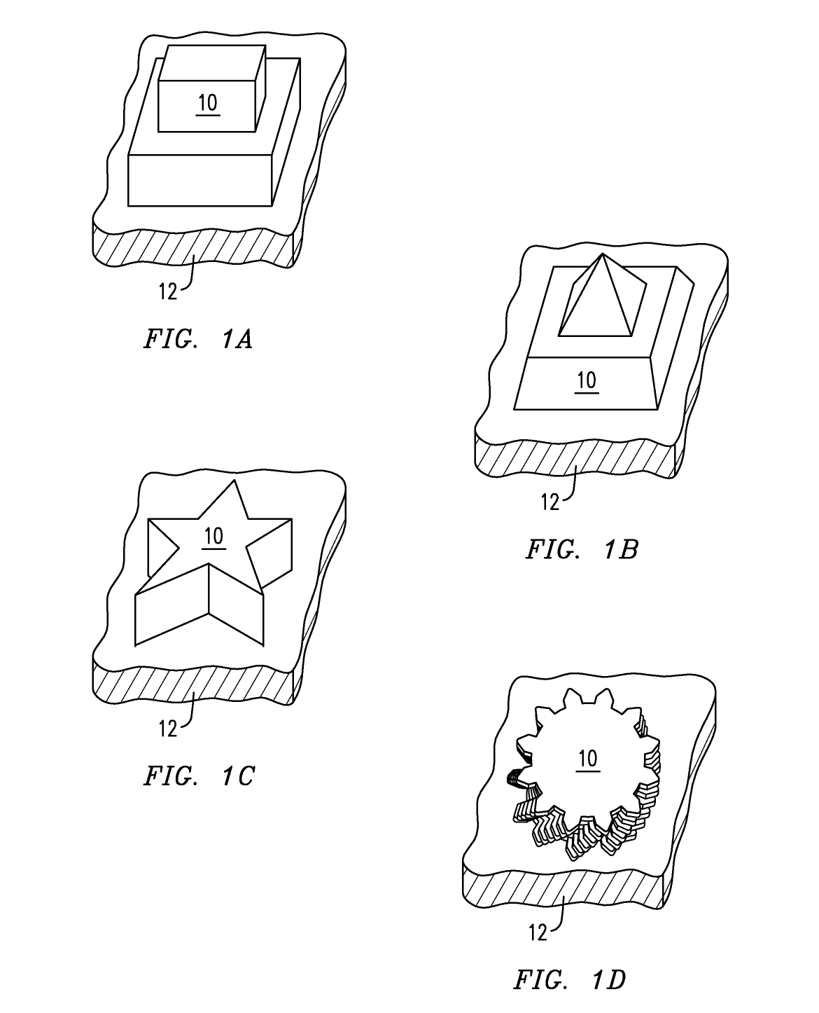

Turning now to the figures, examples of three-dimensional detailed cast features 10 on an object 12 are shown in FIGS. 1A-1D. The shape geometry for the surface feature 10 may include one or more of three-dimensional geometric shapes (e.g, stacked geometric squares, stacked geometric pyramids, 3D raised star, 3D corkscrew/spiral) cast on the object 12 and are not limited to those shown in the figures.

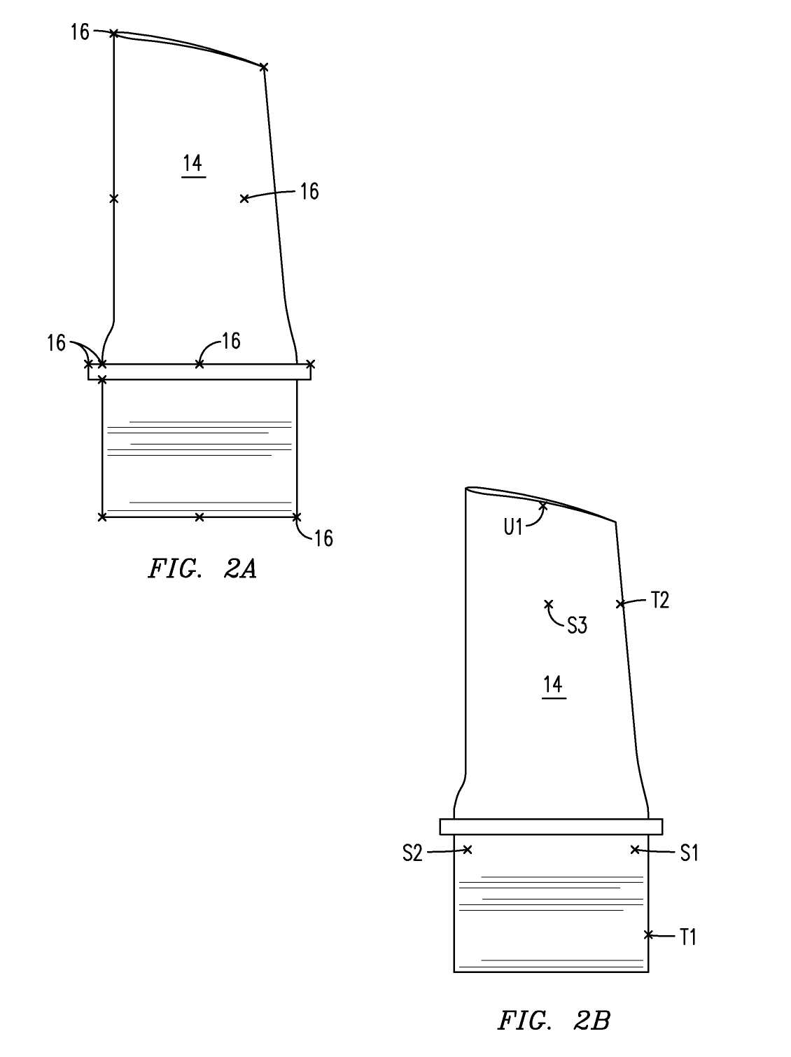

The placement and orientation of the feature(s) depends on the object and the type of analysis to be conducted For example, FIG. 2A illustrates a general turbine blade 14 with placement points 16 indicated thereon. Surface features 10 may be located at these placements points 16 on the blade 14 for blade analysis and inspection. Other placements and orientations are contemplated herein based on the object and analysis

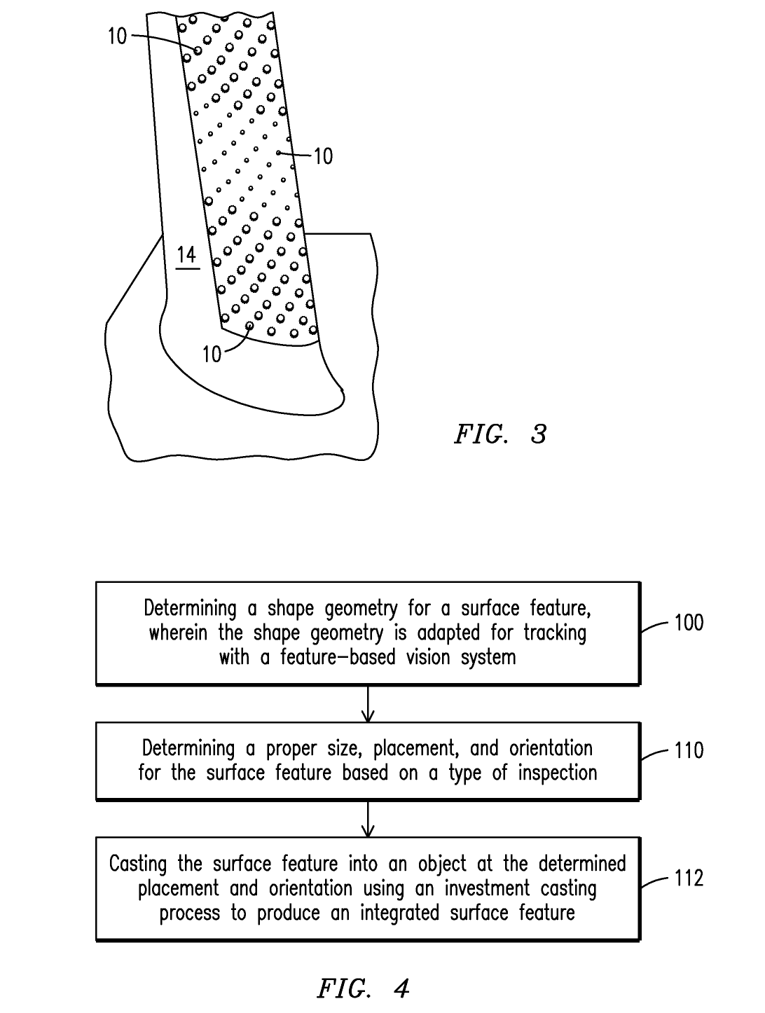

An example leading edge of a blade is shown in FIG. 3 having a plurality of features cast thereon in accordance with the present method.

In a more specifically defined embodiment, the method includes designing a well defined surface feature. This feature preferably includes a predetermined shape geometry and complexity of the shape. The proper placement and orientation of the feature is also determined based on the object and the type of analysis to be conducted. Since the shape geometry and complexity as well as its positioning on the object could affect the feature-based vision system's ability to easily and consistently identify and track from frame to frame and from object to object, proper initial design is important Such design considerations include certain shape sizes, geometries, locations, orientations, and relative positions and orientations of the surface features. Additional considerations may also include feature visibility and/or occlusion, position and distance with respect to the camera/imaging device, resolution capability of the imaging device, and the like.

The shape geometry for the surface feature may include one or more of a three-dimensional geometric shape defined by a set of vertices, lines connecting the vertices, and two-dimensional faces enclosed by those lines, and resulting interior points; a three-dimensional shape bounded by curved surfaces; a three-dimensional mathematically defined shape; a three-dimensional shape made of a combination of two or more shapes, a three-dimensional shaped formed by constructive area geometry (CAG), and a custom three-dimensional shape. The shape geometry may be selected from a database of shapes, including certain complex shapes that provide a better analysis when used with a feature-based vision system. The shape geometry may be created with a CAD or similar program

The proper size, placement, and orientation may be selected based on a type of inspection

For example, in the gas turbine power generation industry, cast features can be designed and specifically placed in an area to assist in measuring creep or twist of a blade or vane Different or additional cast features can be designed and placed in another area to specifically assist in measuring “uncurling” of a ring segment.

Once the feature detail has been selected and the locations identified, the detailed feature is then cast into the object so that it becomes integral to the part. Casting techniques such as that described in US Patent Application Publication No. 20110132563 entitled “Investment casting process for hollow components” (Ser. No. 12/961,720), incorporated herein by reference, may be used to cast the feature detail into the part/object as part of the original casting In the '720 investment casting process, two master mold halves are formed, one corresponding to each of two opposed sides of a desired ceramic core shape Into each master mold a flexible mold material is cast to form two cooperating flexible mold halves, which when joined together define an interior volume corresponding to the desired ceramic core shape. Ceramic mold material is then cast into the flexible mold and allowed to cure to a green state. The flexibility of the mold material enables the casting of component features. Portions of the ceramic core having a relatively high level of detail, such as micro-sized surface turbulators or complex passage shapes, may be translated into the master mold using a precision mold insert.

Once the detail feature(s) is cast into the part/object at the predetermined locations/orientations, the cast feature may be used for location, inspection, and analysis as part of a feature-based vision inspection method. Because the cast feature is actually cast into and integral with the object, consistency in the features is assured from part to part/object to object

The surface feature can be measured by either contact or non contact methods to measure displacement equating to creep, twist or bow Non-contact methods include white or blue light scanning, laser scanning and computer tomography. Contact methods include CMM, caliper and custom gauges Moreover, the surface feature can be measured remotely or in-situ techniques such as high speed camera, infra-red camera and GIS. Further, the surface feature can be configured to accommodate strain and temperature measurement devices (Russian crystal) to provide short term feedback on component stress and temperatures in operation. With these various measurement schemes, the current geometrical state of a component can be quickly assessed via the location measurement of the features relative to baseline location, and hence determine the health of the component

The feature-based vision inspection method may further include, for example, known machine-vision systems and computer-vision systems Such systems may include, for example, CMM (Coordinate Measurement Machine), white light, EDM, laser, and the like, and generally detect the feature or features on the surface of an object These features may be saved as a series of images taken over a predetermined time period The images may then be further processed as part of the analysis Such further processing includes, for example, comparing the feature or features to a template or to a prior image A variety of measurements and comparisons may be taken as part of the processing

In certain industries, such as the gas turbine or wind turbine power generation industry, testing for deflection and twist of turbine blades is conducted using machine-vision systems. These machine-vision systems (such as Boulder Imaging Inc.'s Quazar Vision Inspector) conduct real-time analysis of turbine blade motion using blob detection algorithms to detect known markers on a wind turbine blade as it rotates. By measuring these markers and comparing them to a known reference model of the blade at rest, deflection and twist can be automatically determined The detection algorithms can be adapted to locate and detect the cast features of the present invention, thereby providing a more consistent and accurate testing method.

These features are placed at predetermined points on the blade (or vane or other component) and adapted for location by feature-based vision systems. The location and feature data extracted by the feature-based vision systems can be used to measure creep, twist, or bowing of the part. The particular geometry selected for the feature can also be used for further detailed analysis.

Embodiments herein include a method of designing and manufacturing an object, such as a blade or vane, having cast features for location, inspection, and analysis.

Further embodiments include inspection methods using said cast features.

Embodiments herein also include an object, such as a blade or vane, which has been manufactured in accordance with the methods herein.

Further embodiments include a computer-program product, including one or more non-transitory computer-readable media having computer-executable instructions for performing the steps of a method, for example, according to one of the preceding embodiments.

Another embodiment is an image-capturing means and/or image-processing means including a chipset wherein steps of a method according to one of the above-described examples are implemented

While various embodiments of the present invention have been shown and described herein, it will be obvious that such embodiments are provided by way of example only Numerous variations, changes and substitutions may be made without departing from the invention herein Accordingly, it is intended that the invention be limited only by the spirit and scope of the appended claims.

The invention claimed is:

1. A method for casting an object having an integrated surface feature for location, inspection, and analysis using a feature-based vision system, comprising.
determining a shape geometry for a surface feature, wherein the shape geometry is adapted for tracking with a feature-based vision system;
determining a proper size, placement, and orientation for the surface feature based on a type of inspection, and
casting the surface feature into an object at the determined placement and orientation using an investment casting process to produce an integrated surface feature

2. The method of claim 1, wherein the investment casting process uses a flexible mold wherein the surface feature is translated into a master mold using a precision mold insert.

3. The method of claim 2 wherein the investment casting process use a flexible mold comprises forming two master mold halves, one corresponding to each of two opposed sides of a desired ceramic core shape; translating the surface feature into the master mold using a precision mold insert; casting a flexible mold material into each master mold to form two cooperating flexible mold halves, which when joined together define an interior volume corresponding to the desired ceramic core shape, and casting mold material into the flexible mold to cast the object having the surface feature located thereon.

4. The method of claim 1 further comprising casting a plurality of surface features into the object at a plurality of locations.

5. The method of claim 1 wherein the object comprises a blade or vane.

6. The method of claim 1 wherein the shape geometry, size, orientation, and placement of the surface feature is adapted to assist in measuring creep, twist, or bowing using a feature-based vision system

7. The method of claim 1 wherein the shape geometry for the surface feature comprises one or more of a three-dimensional geometric shape defined by a set of vertices, lines connecting the vertices, and two-dimensional faces enclosed by those lines, and resulting interior points; a three-dimensional shape bounded by curved surfaces, a three-dimensional mathematically defined shape, a three-dimensional shape made of a combination of two or more shapes; a three-dimensional shaped formed by constructive area geometry (CAG); and a custom three-dimensional shape

8. The method of claim 1 further comprising inspecting the object using a feature-based vision system comprising a contact or non-contact measurement system, wherein the feature-based vision system is adapted to track the surface feature using detection algorithms that locate and detect the surface feature

9. The method of claim 8 further comprising outputting an analysis by the feature-based vision system, wherein the analysis is based on a detected movement of the surface feature.

10. The method of claim 9 wherein the detected movement of the surface feature is derived from a current location measurement relative to a prior location measurement.

11. The method of claim 9 wherein the analysis is adapted to detect creep, twist, or bowing using the feature-based vision system.

12. The method of claim 1 wherein the surface feature is further configured to accommodate strain and temperature measurement devices to provide short term feedback on component stress and temperatures

13. An object manufactured in accordance with the casting method of claim 1, wherein the object comprises an integrated surface feature for location, inspection, and analysis using a feature-based vision system.

14. The object of claim 13 wherein the object comprises a gas turbine blade or vane.

15. The object of claim 13 wherein the shape geometry, size, orientation, and placement of the surface feature is adapted to assist in measuring one or more of creep, twist, or bowing using a feature-based vision system.

16. The object of claim 15 wherein the shape geometry for the surface feature comprises one or more of a three-dimensional geometric shape defined by a set of vertices, lines connecting the vertices, and two-dimensional faces enclosed by those lines, and resulting interior points; a three-dimensional shape bounded by curved surfaces; a three-dimensional mathematically defined shape; a three-dimensional shape made of a combination of two or more shapes; a three-dimensional shaped formed by constructive area geometry (CAG); and a custom three-dimensional shape.

17. The object of claim 13 wherein the surface feature is further configured to accommodate strain and temperature measurement devices to provide short term feedback on component stress and temperatures.

18. A method for location, inspection, and analysis of an object using a feature-based vision system, comprising
casting an integrated surface feature into an object by.
determining a shape geometry for a surface feature, wherein the shape geometry is adapted for tracking with a feature-based vision system;
determining a proper size, placement, and orientation for the surface feature based on a type of inspection, and
casting the surface feature into an object at the determined placement and orientation using an investment casting process to produce an integrated surface feature;
inspecting the object using a feature-based vision system comprising a contact or non-contact measurement system, wherein the feature-based vision system is adapted to track the surface feature using detection algorithms that locate and detect the surface feature;
analyzing a detected movement of the surface feature to assist in measuring one or more of creep, twist, or bowing; and
outputting the results of the analysis.

19. The method of claim 18 wherein the detected movement of the surface feature is derived from a current location measurement relative to a prior location measurement

20. The method of claim 18 wherein the surface feature is further configured to accommodate strain and temperature measurement devices to provide short term feedback on component stress and temperatures
